(19) United States
(12) Patent Application Publication
(10) Pub. No.: US 2024/0097168 A1
(43) Pub. Date: Mar. 21, 2024

(54) VEHICLE CONTROLLING START, SHUTDOWN AND RESTART OF FUEL CELL

(71) Applicants: HYUNDAI MOTOR COMPANY, SEOUL (KR); KIA CORPORATION, SEOUL (KR)

(72) Inventors: Beom Sik KIM, Gwangmyeong-si (KR); Kyu Won JEONG, Hwaseong-si (KR); Tae Woo KIM, Anyang-si (KR); Jae Hun JEONG, Anyang-si (KR); Mun Soo CHUNG, Uiwang-si (KR); Sang Don LEE, Suwon-si (KR)

(21) Appl. No.: 18/180,535

(22) Filed: Mar. 8, 2023

(30) Foreign Application Priority Data
Sep. 21, 2022 (KR) 10-2022-0119016

(51) Int. Cl. H01M 8/04858; B60L 50/75; B60L 53/20; H01M 8/04223; H01M 8/04302; H01M 8/04303

(52) U.S. Cl. CPC H01M 8/04858; B60L 50/75; B60L 53/20; H01M 8/04223; H01M 8/04302; H01M 8/04303; H01M 2250/20

(57) ABSTRACT

A vehicle is provided that includes a DC converter having a first end connected to a fuel cell, a second end connected to a high-voltage battery, and at least one switching element connected between the first end and the second end, a fuel cell control unit which controls an activation state of a running command for start of the fuel cell based on an on-off state of vehicle start, and a converter controller which controls a running state of the DC converter according to an initial start sequence, a shutdown sequence, or a restart sequence for the fuel cell based on the activation state of the running command.

### CROSS REFERENCE TO RELATED APPLICATION

The present application claims priority of Korean Patent Application No. 10-2022-0119016 filed on Sep. 21, 2022, the entire contents of which is incorporated herein for all purposes by this reference.

### BACKGROUND

### 1. Technical Field

The present disclosure relates to a vehicle for starting, shutting down and restarting a fuel cell stably and efficiently.

### 2. Related Art

As interest in the environment increases, the development of an electrified vehicle having a motor as a driving source is being actively conducted. An example of such an electrified vehicle may be a fuel cell electric vehicle (FCEV).

The fuel cell electric vehicle may refer to a vehicle which travels in such a way so as to drive an electric motor with electric power generated through a chemical reaction between hydrogen and oxygen in the fuel cell. In order to stably supply power to a motor, a high-voltage battery may be provided between a fuel cell and a motor driving system including an electric motor and an inverter, and there is a trend of increasing the voltage of the high-voltage battery in order to increase efficiency and storage capacity.

Accordingly, the voltage of the high-voltage battery may become significantly higher than the voltage of the fuel cell, and in such case, a DC converter may be disposed between the fuel cell and the high-voltage battery to enable power exchange between the fuel cell and the high-voltage battery.

The matters described above as the background art are only for facilitating a better understanding of the background of the present disclosure, and should not be taken as an acknowledgment that they correspond to the prior art already known to those of ordinary skill in the art.

### SUMMARY

Accordingly, it is an object of the present disclosure to achieve stably and efficiently starting, shutting down and restarting of a fuel cell by performing an initial start sequence, a shutdown sequence, or a restart sequence for the fuel cell through cooperative control of a controller for the fuel cell and a controller for a DC converter.

Technical drawbacks, which the present disclosure is to address, are not limited to the aforementioned ones, and unmentioned other technical drawbacks may be clearly appreciated from the following detailed description by a person having ordinary skill in the art to which the present disclosure belongs.

As a means for solving the above-described technical problems, a vehicle may include a DC converter having a first end connected to a fuel cell, a second end connected to a high-voltage battery, and at least one switching element connected between the first end and the second end, a fuel cell control unit which controls an activation state of a running command for start of the fuel cell based on an on-off state of vehicle start, and a converter controller which controls a running state of the DC converter according to an initial start sequence, a shutdown sequence, or a restart sequence for the fuel cell based on the activation state of the running command.

According to the present disclosure, it is possible to stably and efficiently start, shut down and restart a fuel cell by performing an initial start sequence, a shutdown sequence, or a restart sequence for the fuel cell through cooperative control of a controller for the fuel cell and a controller for a DC converter.

Advantageous effects, which the disclosure may provide, are not limited to the aforementioned ones, and unmentioned other ones may be understood from the following detailed description by a person having an ordinary skill in the art to which the disclosure belongs.

### BRIEF DESCRIPTION OF THE DRAWINGS

The following drawings accompanying this specification illustrate preferred embodiments of the present disclosure, and serve to facilitate a better understanding of the technical spirit of the present disclosure together with the detailed description of the present disclosure to be described later, so the present disclosure should not be construed as being limited only to the matters described in such drawings.

FIG. 1 shows an example of the configuration of a power electronic system of a fuel cell electric vehicle according to an embodiment of the present disclosure.

FIG. 2 shows an example of the configuration of a control system of a fuel cell electric vehicle according to an embodiment of the present disclosure.

FIG. 3 shows an example of an operation process of a fuel cell control unit and a converter controller according to an embodiment of the present disclosure.

FIG. 4 shows an example of an initial start sequence for a fuel cell according to an embodiment of the present disclosure.

FIG. 5 shows an example of a shutdown sequence for a fuel cell according to an embodiment of the present disclosure.

FIG. 6 shows an example of a restart sequence for a fuel cell according to an embodiment of the present disclosure.

FIG. 7 is a flowchart illustrating an example of a control process of a fuel cell electric vehicle according to an embodiment of the present disclosure.

### DETAILED DESCRIPTION

Hereinafter, exemplary embodiments disclosed herein will be described with reference to the accompanying drawings, in which identical or like components are given like reference numerals regardless of reference symbols, and repeated description thereof will be omitted. Suffixes for components, “module” and “part” used in the following description, will be given or used in place of each other taking only easiness of specification preparation into consideration, and they do not have distinguishable meanings or roles by themselves. Additionally, it is noted that the detailed description for related prior arts may be omitted herein so as not to obscure essential points of the disclosure. Further, the accompanying drawings are intended to facilitate a better understanding of examples disclosed herein, and the technical spirit disclosed herein is not limited by the accompanying drawings, and rather should be construed as including all the modifications, equivalents and substitutes within the spirit and technical scope of the disclosure.

The terms including ordinal number such as, first, second and the like may be used to explain various components, but the components are not limited by the terms. Said terms are used in order only to distinguish one component from another component.

Further, when one component is referred to as being “connected” or “accessed” to another element, it should be understood that the one component may be directly connected or accessed to the other component or any intervening component may also be present therebetween. Contrarily, when one component is referred to as being “directly connected” or “directly accessed” to another component, it should be understood as that no other element is present therebetween.

Singular expressions may include the meaning of plural expressions unless the context clearly indicates otherwise.

The terms such as “include (or comprise)”, “have (or be provided with)”, and the like are intended to indicate that features, numbers, steps, operations, components, parts, or combinations thereof written in the following description exist, and thus should not be understood as that the possibility of existence or addition of one or more different features, numbers, steps, operations, components, parts, or combinations thereof is excluded in advance.

Additionally, a unit or a control unit included in the names of a motor control unit (MCU), a hybrid control unit (HCU), and the like is only a term widely used in the naming of a controller that controls a specific vehicle function. However, it does not mean a generic function unit. For example, each controller may include a communication apparatus that communicates with other controllers or sensors to control the functions for which it is responsible, a memory that stores operating system or logic instructions, input/output information, and the like, and one or more processors that perform judgments, calculations, decisions, and the like necessary to control the functions which it is responsible for.

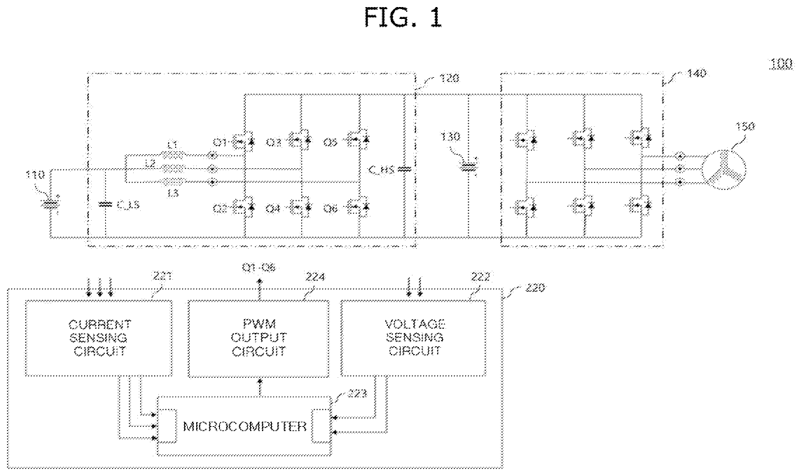

FIG. 1 shows an example of the configuration of a power electronic system of a fuel cell electric vehicle according to an embodiment of the present disclosure.

Referring to FIG. 1, a fuel cell electric vehicle 100 according to an embodiment may include a fuel cell 110, a fuel cell DC converter (FDC) 120 with one end to which the fuel cell 110 is connected, a high-voltage battery 130 connected to the other end of the DC converter 120, an inverter 140 with a DC-link connected to the other end of the DC converter 120, and a motor 150 connected to an AC-link of the inverter 140.

The fuel cell 110 may output power through a chemical reaction between hydrogen and oxygen. For example, the fuel cell 110 may have a form of a polymer electrolyte membrane fuel cell (PEMFC: Polymer Electrolyte Membrane Fuel Cell, Proton Exchange Membrane Fuel Cell), but this is exemplary and is not necessarily limited thereto.

The DC converter 120 has two DC-links, that is, one end electrically connected to the fuel cell 110, and the other end electrically connected to the high-voltage battery 130, and may perform a function of transforming the voltage of power inputted from one end to correspond to the voltage of the other end and outputting the voltage to the other end. To this end, the DC converter 120 may include a first capacitor C_LS for stably maintaining the voltage at one end, a second capacitor C_HS for stably maintaining the voltage at the other end, and a plurality of inductor-leg pairs connected between one end and the other end. The plurality of inductor-leg pairs form a boost topology for voltage transformation, and for this purpose, switching elements included in the legs may be electrically connected to the fuel cell 110 through inductors.

Here, assuming that the normal voltage range of the fuel cell 110 is relatively lower than the normal voltage range of the high-voltage battery 130, one end may be referred to as a low side, and the other end may be referred to as a high side. The first capacitor C_LS may be connected between the negative (−) terminal and the positive (+) terminal of the low side, and the second capacitor C_LS may be connected between the negative (−) terminal and the positive (+) terminal of the high side. Here, the first capacitor C_LS may be referred to as a ‘low-side capacitor’, and the second capacitor C_HS may be referred to as a ‘high-side capacitor’.

Also, the plurality of inductor-leg pairs may be connected in parallel between the low-side capacitor C_LS and the high-side capacitor C_HS. In more detail, one end of each of a plurality of inductors L1, L2, L3 may be connected to the positive (+) terminal of the low side, and the other end may be connected to a corresponding one of a plurality of legs Q1-Q2, Q3-Q4, and Q5-Q6 to form inductor-leg pairs.

Each of the plurality of legs Q1-Q2, Q3-Q4, Q5-Q6 may include two switching elements interconnected in series between both ends of the high-side capacitor C_HS, and the connection node of the two switching elements may be connected to the other end of the inductor constituting the inductor-leg pair. For example, the first leg Q1-Q2 includes the first switching element Q1 and the second switching element Q2 connected in series between both ends of the high-side capacitor C_HS, and the connection node of the two switching elements Q1 and Q2 may be connected to the other end of the first inductor L1 to form the first inductor-leg pair. The first switching element Q1 may be referred to as a ‘top switching element’, and the second switching element Q2 may be referred to as a ‘bottom switching element’.

Each switching element may be implemented as a power semiconductor device capable of high-power and high-speed switching, for example, an insulated gate bipolar transistor (IGBT), but is not limited thereto.

A converter controller 220 may include a current sensing circuit 221 for processing the current value sensed by the current sensor of the low side, a voltage sensing circuit 222 for processing a voltage value sensed by each voltage sensor of the low side and the high side, a microcomputer 223 for controlling the operation of the DC converter 120 using the sensed current and voltage values, and a PWM output circuit 224 for outputting a pulse width modulation signal PWM for switching the switching elements Q1-Q6. In this case, the microcomputer 223 may control the duty ratio of the plurality of legs Q1-Q2, Q3-Q4, Q5-Q6, or the like based on the output current target value of the DC converter 120. Here, the output current target value of the DC converter 120 may be information transmitted from a fuel cell control unit (FCU) to be described later. According to an embodiment, the converter controller 220 and the DC converter 120 may be implemented as an integrated module.

The inverter 140 may convert the DC power of the high-voltage battery 130 into multi-phase AC power to drive the motor 150, or convert the AC power generated by the motor 150 into DC power and transmit it to the high-voltage battery 130. To this end, the inverter 140 may have a plurality of legs corresponding to each of the multi-phases. Since it is apparent to those skilled in the art that the multi-phase motor and the inverter for driving the same may be implemented in various configurations, a further detailed description thereof will be omitted.

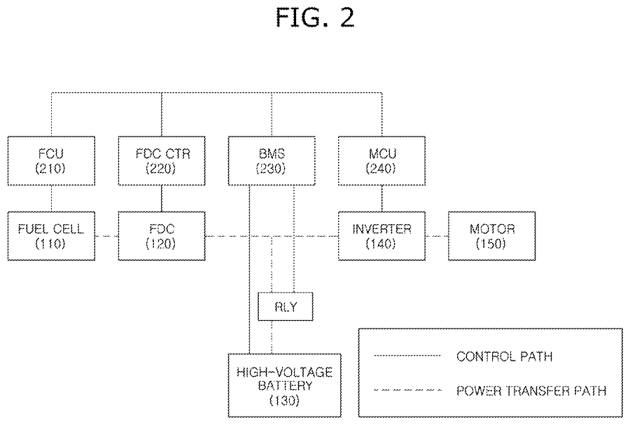

Based on the configuration of the power electronic system described above with reference to FIG. 1, a control system of the fuel cell vehicle will be described with reference to FIG. 2.

FIG. 2 is a view showing a control system of a fuel cell electric vehicle according to an embodiment of the present disclosure, together with a power electronic system.

In FIG. 2, a solid line connecting between respective components indicates a control signal transmission path, and a dotted line indicates a power transmission path, respectively. In addition, in the description of FIG. 2, since the power transmission path is the same as that described with reference to FIG. 1, the overlapping description will be omitted.

Referring to FIG. 2, the fuel cell 110 may be controlled by the fuel cell control unit (FCU) 210, and the control of the DC converter 120 may be performed by the converter controller 220. In addition, the battery control management system (BMS) 230 may control the ON/OFF state of the relay RLY, and manage the state of the high-voltage battery 130.

In addition, a motor control unit (MCU, 240) may control a gate drive unit (not shown) with a control signal in the form of pulse width modulation (PWM) based on the motor angle of the motor 150, phase voltage, phase current, required torque, or the like, and the gate driving unit may accordingly control the inverter 140 driving the motor 150.

The respective control entities 210, 220, 230, and 240 may exchange with each other information or commands required for control through communication according to a predetermined vehicle communication protocol, for example, controller area network (CAN) communication.

Hereinafter, an operation method in which the fuel cell control unit 210 and the converter controller 220 stably and efficiently start, shut down, and restart the fuel cell 110 by performing an initial start sequence, shutdown sequence or restart sequence of the fuel cell 110 through cooperative control, will be described.

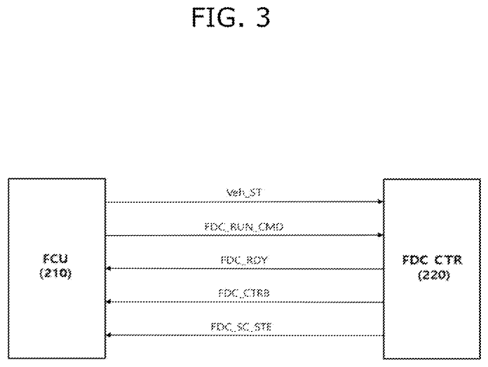

FIG. 3 shows an example of an operation process of the fuel cell control unit 210 and the converter controller 220 according to an embodiment of the present disclosure.

Referring to FIG. 3, the fuel cell control unit 210 and the converter controller 220 may perform an initial start sequence, a shutdown sequence, or a restart sequence for the fuel cell 110 based on the start state of the vehicle by transmitting and receiving information or commands related to the control of the DC converter 120 according to a predetermined vehicle communication protocol.

For example, the initial start sequence for the fuel cell 110 may be performed in a way that the DC converter 120 supplies power to a balance of plant (BoP) of the fuel cell 110 based on the voltage of the high-voltage battery 130. Also, the shutdown sequence for the fuel cell 110 may be performed in such a way that the DC converter 120 cuts off the power supplied to the balance of plant (BoP) of the fuel cell 110. In addition, the restart sequence for the fuel cell 110 may be performed in such a way that the DC converter 120 cuts off the power supplied to the balance of plant (BoP) of the fuel cell 110 and then supplies the power again. Here, the balance of plant (BoP) of the fuel cell 110 may include, for example, a hydrogen and air supply system, a cooling system, and an electric circuit system related to the fuel cell 110.

The fuel cell control unit 210 may transmit the start state signal Veh_ST to the converter controller 220 based on the on-off state of the vehicle start. The vehicle start may be in an on state when Key_IG is on, and may be in an off state when Key_IG is off. The start state signal Veh_ST may be activated after a preset time period from the time when the vehicle start is in the on state.

In addition, the fuel cell control unit 210 may control the activation state of the run command FDC_RUN_CMD for start of the fuel cell 110 based on the on-off state of the vehicle start, and transmit the run command FDC_RUN_CMD to the converter controller 220.

More specifically, when the vehicle start is switched from the off state to the on state, the fuel cell control unit 210 may activate the running command FDC_RUN_CMD so that the fuel cell 110 is started. The fuel cell control unit 210 may output the output current target value for the DC converter 120 to the converter controller 220 together with the output of the running command FDC_RUN_CMD. When the running command FDC_RUN_CMD is activated, based on the output current target value, the converter controller 220 may control power transfer between the fuel cell 110 and the high-voltage battery 130 by switching the switching element included in the DC converter 120.

In addition, when the vehicle start is switched from the on state to the off state, and if the vehicle start is not switched to the on state for a predetermined period of time, the fuel cell control unit 210 may deactivate the running command FDC_RUN_CMD so that the fuel cell 110 is shut down.

In addition, when the vehicle start is switched from the on state to the off state and then switched back to the on state within a predetermined period of time, the fuel cell control unit 210 may reactivate the running command FDC_RUN_CMD after deactivating it so that the fuel cell 110 is restarted.

The converter controller 220 may transmit a communication ready state signal FDC_RDY and a DC transformation start signal FDC_CTRB to the fuel cell control unit 210.

When the vehicle start is switched from the off state to the on state, and if the converter controller 220 is in a state in which communication with the fuel cell control unit 210 is possible through a method such as a controller area network (CAN), the communication ready state signal FDC_RDY may be activated.

In a state in which the running command FDC_RUN_CMD is activated according to the on state of the vehicle start, when the powering of the DC converter 120 is in an enabled state, that is, when the switching element included in the DC converter 120 is switched, the DC transformation start signal FDC_CTRB may be activated.

In addition, based on the activation state of the running command FDC_RUN_CMD, according to an initial start sequence, a shutdown sequence, or a restart sequence for the fuel cell 110, the converter controller 220 may control the running state of the DC converter 120. In this case, the converter controller 220 may transmit the running state information FDC_SC_STE indicating the running state of the DC converter 120 to the fuel cell control unit 210.

In this embodiment, the running state of the DC converter 120 may include an initial check state, a standby state, a pre-active state, and an active state. For example, the initial check state may correspond to a state in which the converter controller 220 performs initialization operations on the current sensor and the voltage sensor of the DC converter 120. The standby state may correspond to a state in which a powering operation for the DC converter 120 is prepared after the initialization operation is completed. The pre-active state may correspond to a state in which before the converter controller 220 performs a powering operation on the DC converter 120, it checks whether values sensed by the current sensor and the voltage sensor of the DC converter 120 are within a preset range. The active state may correspond to a state in which the converter controller 220 performs a powering operation for the DC converter 120 after completing the check operation in the pre-active state. That is, the active state may correspond to a state in which the converter controller 220 switches the switching element included in the DC converter 120.

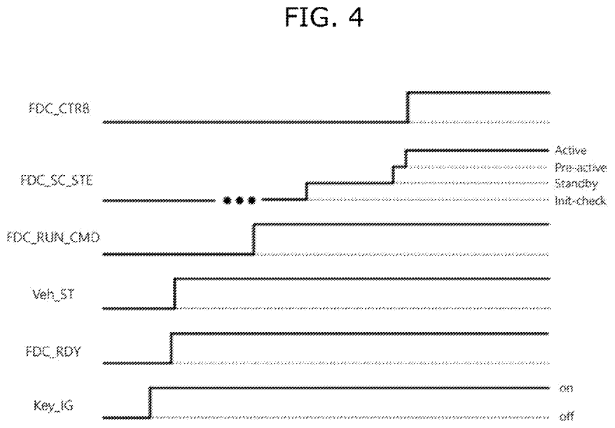

A method in which the fuel cell control unit 210 and the converter controller 220 transmit the signals shown in FIG. 3 based on the on-off state of vehicle start will be described in detail with reference to FIGS. 4 to 6.

FIG. 4 shows an example of an initial start sequence for a fuel cell according to an embodiment of the present disclosure.

Referring to FIG. 4, the vehicle start may be in an on state when Key_IG is on, and may be in an off state when Key_IG is off.

When the vehicle start is switched from the off state to the on state, the fuel cell control unit 210 may transmit the activated start state signal Veh_ST to the converter controller 220, and the converter controller 220 may transmit the activated communication ready state signal FDC_RDY to the fuel cell control unit 210.

After that, when the vehicle start is switched from the off state to the on state, the fuel cell control unit 210 may activate the running command FDC_RUN_CMD so that the fuel cell 110 is started. In this case, the fuel cell control unit 210 may transmit the running command FDC_RUN_CMD to the converter controller 220 based on the activated communication ready state signal FDC_RDY.

When the running command FDC_RUN_CMD is activated, the converter controller 220 may cause the transition of the running state of the DC converter 120 indicated by the running state information FDC_SC_STE from an initial check state Init-check to a standby state Standby, a pre-active state “Pre-active”, and an active state “Active”, in that order, according to the initial start sequence.

Also, the converter controller 220 may activate the DC transformation start signal FDC_CTRB when the switching element included in the DC converter 120 is switched while the running command FDC_RUN_CMD is activated.

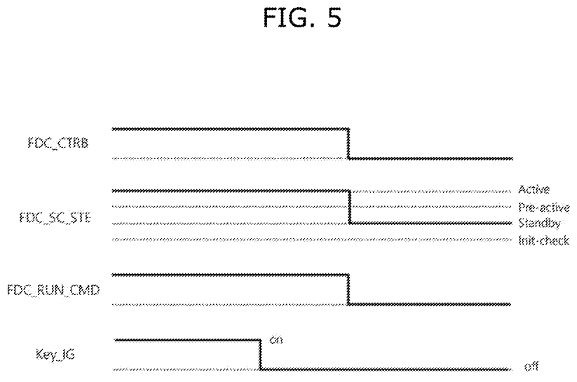

FIG. 5 shows an example of a shutdown sequence for a fuel cell according to an embodiment of the present disclosure.

Referring to FIG. 5, the fuel cell control unit 210 may deactivate the running command FDC_RUN_CMD so that the fuel cell 110 is shut down when the vehicle start is switched from an on state to an off state.

When the activated running command FDC_RUN_CMD is deactivated, the converter controller 220 may cause the transition of the running state of the DC converter 120 indicated by the running state information FDC_SC_STE from the active state to the standby state according to the shutdown sequence.

Also, the converter controller 220 may deactivate the DC transformation start signal FDC_CTRB when the activated running command FDC_RUN_CMD is deactivated.

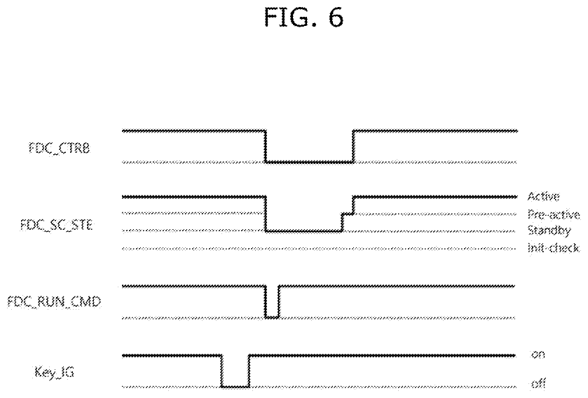

FIG. 6 illustrates an example of a restart sequence for a fuel cell according to an embodiment of the present disclosure.

Referring to FIG. 6, when the vehicle start is switched from the on state to the off state and then switched back to the on state within a predetermined period of time, the fuel cell control unit 210 may reactivate the running command FDC_RUN_CMD after deactivating it so that the fuel cell 110 is restarted.

When the deactivated running command FDC_RUN_CMD is re-activated, the converter controller 220 may cause the transition of the running state of the DC converter 120 indicated by the running state information FDC_SC_STE from a standby state (Standby) to a pre-active state Pre-active, and an active state Active in that order according to the restart sequence.

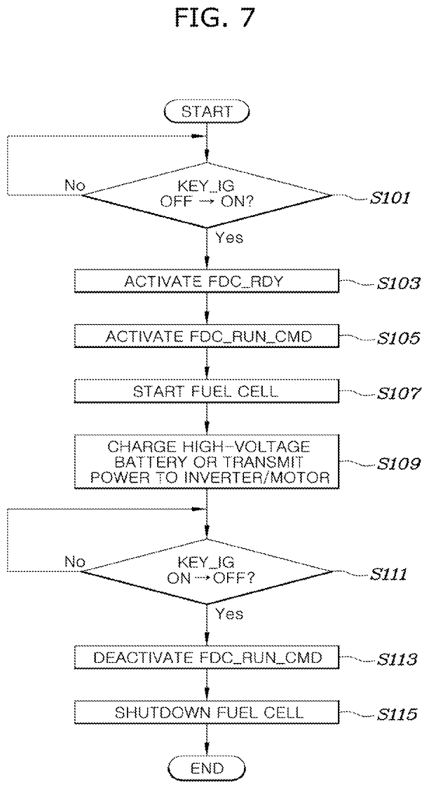

FIG. 7 is a flowchart illustrating an example of a control process of a fuel cell electric vehicle according to an embodiment of the present disclosure.

Referring to FIG. 7, the vehicle start may be switched from an off state to an on state depending on whether Key_IG is turned on (S101).

When the vehicle start is switched from the off state to the on state (YES in S101), the converter controller 220 may activate the communication ready state signal FDC_RDY when communication with the fuel cell control unit 210 is possible (S103).

When the vehicle start is switched from the off state to the on state (YES in S101), the fuel cell control unit 210 may activate the running command FDC_RUN_CMD for starting the fuel cell 110, and transmit the running command FDC_RUN_CMD to the converter controller 220 based on the activated communication readiness signal FDC_RDY (S105).

When the running command FDC_RUN_CMD is activated, based on the voltage of the high-voltage battery 130, by switching at least one switching element included in the voltage DC converter 120 to supply power to the balance of plant (BoP) of the fuel cell 110, the converter controller 220 may perform an initial start sequence for the fuel cell 110 (S107).

When the initial start sequence of the fuel cell 110 is completed, the converter controller 220 may charge the high-voltage battery 130 or transmit power to the inverter 140 and the motor 150 by switching at least one switching element included in the voltage DC converter 120 based on the voltage of the fuel cell 110 (S109).

Thereafter, depending on whether Key_IG is turned off, the vehicle start may be switched from an on state to an off state (S111).

When the vehicle start is not switched from the on state to the off state (NO in S111), S109 may be re-performed.

When the vehicle start is switched from the on state to the off state (YES in S111), the fuel cell control unit 210 may deactivate the running command FDC_RUN_CMD, so that the fuel cell 110 is shut down (S113).

When the running command FDC_RUN_CMD is deactivated, the converter controller 220 may perform a shutdown sequence for the fuel cell 110 by cutting off the power supplied to the balance of plant (BoP) of the fuel cell 110 (S115).

The shutdown sequence for the fuel cell 110 in FIG. 7 has been described under the assumption that Key_IG is not turned on for a predetermined period of time after Key_IG has been off in S111. If Key_IG is turned off in S111 and then is turned on again within a predetermined period of time, a restart sequence for the fuel cell 110 may be performed.

Meanwhile, the disclosure described above may be embodied as a computer-readable code in a medium in which program is recorded. A computer-readable medium includes all kinds of recorders where data that can be read by a computer system is stored. Examples of computer-readable media are hard disk drives (HDDs), solid state disks (SSDs), Silicon disk drives (SDDs), ROMs, RAMs, CD-ROMs, magnetic tape, floppy disks, optical data storage devices, and the like. Therefore, the detailed description above should not be interpreted in a limited way but should be considered as an example. The scope of the disclosure shall be determined by a reasonable interpretation of the claims attached, and all changes within the equivalent range of the disclosure are within the scope of the disclosure.

What is claimed is:

1. A vehicle comprising:
a DC converter having a first end connected to a fuel cell, a second end connected to a high-voltage battery, and at least one switching element connected between the first end and the second end;
a fuel cell control unit which controls an activation state of a running command for start of the fuel cell based on an on-off state of vehicle start; and
a converter controller which controls a running state of the DC converter according to an initial start sequence, a shutdown sequence, or a restart sequence for the fuel cell based on the activation state of the running command.

2. The vehicle according to claim 1, wherein when the vehicle start is switched from the off state to the on state, the fuel cell control unit activates the running command so that the fuel cell starts.

3. The vehicle according to claim 1, wherein when the vehicle start is switched from the on state to the off state, the fuel cell control unit deactivates the running command so that the fuel cell is shut down.

4. The vehicle according to claim 1, wherein when the vehicle start is switched back to the on state after having been switched from the on state to the off state, the fuel cell control unit deactivates and then reactivates the running command so that the fuel cell is restarted.

5. The vehicle according to claim 1, wherein the running state of the DC converter includes an initial check state, a standby state, a pre-active state, and an active state.

6. The vehicle according to claim 5, wherein when the running command is activated, the converter controller causes transition of the running state of the DC converter from the initial check state to the standby state, then the pre-active state, and then the active state, according to the initial start sequence.

7. The vehicle according to claim 5, wherein when the running command is deactivated, the converter controller causes transition of the running state of the DC converter from the active state to the standby state according to the shutdown sequence.

8. The vehicle according to claim 5, wherein when the deactivated running command is reactivated, the converter controller causes transition of the running state of the DC converter from the standby state to the pre-active state and then to the active state, according to the restart sequence.

9. The vehicle according to claim 1, wherein when the vehicle start is switched from the off state to the on state, the converter controller transmits a communication ready state signal to the fuel cell control unit, and
wherein the fuel cell control unit transmits the running command to the converter controller based on the communication ready state signal.

10. The vehicle according to claim 1, wherein the fuel cell control unit outputs an output current target value for the DC converter together with output of the running command.

11. The vehicle according to claim 10, wherein when the running command is activated, the converter controller controls power transfer between the fuel cell and the high-voltage battery by switching the at least one switching element based on the output current target value.

12. The vehicle according to claim 11, wherein when the at least one switching element is switched, the converter controller transmits a DC transformation start signal for the DC converter to the fuel cell control unit.

13. The vehicle according to claim 1, wherein the at least one switching element is connected to the fuel cell through an inductor.
